(19) United States
(12) Patent Application Publication
(10) Pub. No.: US 2001/0031456 A1
(43) Pub. Date: Oct. 18, 2001

(54) Education system and method for providing educational exercises and establishing an educational fund

(76) Inventors: Greg Cynaumon, Anaheim, CA (US); Steve Tucker, Newport Beach, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/742,746

(22) Filed: Dec. 20, 2000

Related U.S. Application Data
(60) Provisional application No. 60/174,080, filed on Dec. 30, 1999.
(60) Provisional application No. 60/211,143, filed on Jun. 13, 2000.
(60) Provisional application No. 60/228,143, filed on Aug. 25, 2000.
(60) Provisional application No. 60/236,563, filed on Sep. 29, 2000.

(51) Int. Cl. G09B 3/00

(52) U.S. Cl. 434/350

(57) ABSTRACT

The present invention is an educational system which adapts at least portions of educational content to a learning style of a student, provides substantially immediate and effective feedback of student performance to parents, and incentivises each participant in the students' education to use the system. For example, the educational system presents interactive educational lessons and exercises to a student to determine the student's learning style or modality. Thereafter, the educational system adapts the presentation to the modality. In addition, the education system provides homework curriculum and educational content based on, for example, the student current educational needs or scholastic exercises. Moreover, the educational system provides rewards to teachers, students, and parents for using the system. For example, the education system enables parents to accumulate a fund for college education. The fund may be increased through rewards for using cash back credit cards, purchasing goods online, lottery-style awards, use of the online education system, or the like.

### REFERENCE TO RELATED APPLICATION

The present application claims priority benefit under 35 U.S.C. §119(e) from U.S. Provisional Application No. 60/174,080 filed Dec. 30, 1999 entitled “SYSTEM AND METHOD FOR IMPROVING VOCABULARY, SPELLING AND COMPREHENSION SKILLS OF INDIVIDUALS,” U.S. Provisional Application No. 60/211,341 filed Jun. 13, 2000 entitled “IMPROVED METHOD OF LEARNING THROUGHOUT AN INDIVIDUAL'S LIFETIME,” U.S. Provisional Application No. 60/228,143 filed Aug. 25, 2000 entitled “IMPROVED EDUCATIONAL METHOD (TEACHER DIRECT),” and U.S. Provisional Application No. 60/236,563 filed Sep. 29, 2000 entitled “SYSTEM AND METHOD OF PROVIDING EDUCATIONAL CONTENT AND COMMERCE,” which are herewith incorporated by reference.

### BACKGROUND OF THE INVENTION

1. Field of the Invention

The invention relates in general to a computer-based education system, and in particular to an education system for improving individual skills over a lifetime through education adapted to learning styles or preferences, and the establishment of an educational fund.

2. Description of Related Art

The traditional method of educating students is to send them to a school or similar educational institution to learn by following the instructions of a teacher. The teacher presents the educational curriculum to the students and assists them in retaining the information. One drawback of the foregoing traditional method is rooted in the fact that students are often predisposed to effective learning in different ways. For example, some students have a visual learning preference, while others have auditory or kinesthetic learning preferences. Therefore, not all students can succeed with the foregoing traditional methods. Moreover, the students that may succeed using the instructions of a teacher, are often learning in a manner inconsistent with their learning strengths or style.

In addition, the traditional method of providing feedback to guardians, for example, parents, for a particular student is confined to reports of test results that are then sent to the guardians of the student in the form of a report card. Generally, the foregoing report card is delivered by the student or is sent by mail. However, this method of feedback also suffers from a variety of drawbacks. For example, when a student is having difficulty learning at school, the guardians are often not notified in a timely enough fashion to address the problem. In fact, the report card process often allows an entire school term to pass before the guardian is made aware of these problems. Another drawback is that some students will lose or modify the report card before it reaches the guardian.

To attempt to remedy the foregoing drawbacks related to parental feedback, some educational institutions post report cards on computer systems accessible to the guardians by means such as the Internet. However, these computer systems do not give a compelling reason to teachers, guardians, or students to participate. For example, teachers may lack the time or computer knowledge to enter data into an often cumbersome data entry and presentation system. Also, guardians, such as, parents, often neglect or forget to check the results. Moreover, students often are not compelled to use the foregoing systems or find the systems cumbersome to use. As a result, the traditional computer systems fail to create an effective means of keeping guardians informed of and involved in their student's learning progress.

### SUMMARY OF THE INVENTION

Based on the foregoing, a need exists for an education system adaptable to learning styles or preferences. In addition, a need exists for an education system that accounts for the differing learning styles of students, provides effective feedback to parents, and incentivises each participant in the student's education to use the system. Accordingly, one aspect of the invention is to educate students according to the individual student's learning style and preference. According to another aspect, the education system adapts as the student learns and grows.

Another aspect of the invention is to provide effective communication between guardians, such as, parents, teachers, and students. For example, such communication may advantageously include guardians being informed of their student's learning progress at a dramatically increased timeframe. For example, according to one embodiment, the invention includes a notification system, which can be adapted to notify guardians of a student's progress or performance. Such notification may be substantially immediate to the extent that test results may advantageously be scored, and thereafter distributed through the notification system to the guardian.

In addition, another aspect of the invention enables a teacher to offer immediate corrective or restorative curriculum choices to students. For example, the teacher may advantageously offer corrective curriculum to students who do poorly on an exam or other performance yardstick through online supplemental curriculum. Such offerings may advantageously be highly relevant in that the supplemental curriculum may correspond to, for example, the subject area the student and his or her class are currently engaged in.

Yet another aspect of the invention motivates or incentivises students, teachers, and parents to effectively and frequently utilize the education system. For example, the invention rewards students for learning through an online reward system. Moreover, the invention provides a plurality of opportunities for guardians, students, relatives, or acquaintances to build college education funds for particular students or groups of students. For example, the college education fund can be build through online Internet purchasing activities, the use of a credit cards having cash-back for college functionality, or through retail partnerships who distribute a portion of purchases to the college fund.

Another aspect of the invention is an education system for determining a learning style of a student and presenting educational content to the student, wherein the presentation is at least partially adapted to the learning style of the student. The education system comprises an educational lesson manager which provides educational content to a student through a presentation. The education system also comprises a learning modality evaluator which evaluates a student performance to determine a learning style of the student. The educational system further comprises a modality adapter which modifies at least a portion of the presentation based on the learning style of the student.

Another aspect of the invention is a method of incentivising participants in a student's education to use an electronic education system which conveys at least information related to the student's education. The method comprises providing teacher incentives to a teacher to access an electronic education system, wherein the electronic education system enhances the education of a student. The method also comprises providing student incentives to a student to access the electronic education system. The method further comprises providing guardian incentives to a guardian of the student to access the electronic education system.

Another aspect of the invention is an automatic notification system for notifying a guardian of a performance of a student during one or more educational exercises. The notification system comprises an electronic education system which stores an indicator of the performance of a student during one or more educational exercises. The notification system also comprises a transmission system connected to the education system. The notification system further comprises a guardian computing device connected to the transmission system, which receives a notification of the indicator from the electronic education system through the transmission system, thereby providing a guardian of the student with feedback on the performance of the student during the one or more educational exercises.

Another aspect of the invention is an education system for improving the education of a student. The education system comprises a trust which stores rewards on behalf of a student, the rewards being earned by one of the student, a guardian of the student, a benefactor of the student, and a teacher. The education system also comprises an education portal providing one or more educational exercises adapted to a learning style of the student, wherein the education portal includes a notification system which generates a notification for a guardian computing device of a result of the student performing the one or more educational exercises, the result corresponding to the performance of the one or more educational exercises.

Another aspect of this invention is an education system. The education system comprises a teacher area which accesses educational content on behalf of a teacher. The education system also comprises a student area which provides one or more interactive educational exercises that are at least partially adapted to a learning modality of a student. The education system further comprises a notification system which generates a notification having performance indicators corresponding to the performance of the student during the one or more educational exercises. The education system also comprises a family area which receives the notification. The education system further comprises one or more databases which store data corresponding to at least portions of the educational content, the learning modality, and the performance indicators. Accordingly, the use of the education system by one of the teacher, the family, and the student, produces rewards to be stored in a trust on behalf of one of the one of the teacher, the family, and the student.

Another aspect of the invention is a method of incentivising one or more participants in a student's education to use an electronic education system which conveys at least information related to the student's education. The method comprises offering one or more rewards based on an amount of use of an electronic education system by one or more participants in a student's education, wherein the one or more rewards correspond to at least one desired item of the at least one participant. The method also comprises a method of providing relevant online educational content and exercises to a user. The method of providing relevant online educational content comprises selecting homework exercises or presentations from a database storing educational content, the selection being based on subject matter corresponding to subject matter a student currently is engaged in. The method of providing relevant online educational content also comprises assigning the selected exercises or presentations to the student through an electronic educational system accessible to the student. The method of providing relevant online educational content further comprises monitoring the student's performance during at least one of the selected exercises or presentations.

Another aspect of this invention is a method of distributing homework to one or more students through an electronic educational system. The method comprises receiving a request from the teacher to assign particular homework to one or more students. The method also comprises selecting a portion of educational content stored in one or more databases, the portion corresponding to the particular homework. The method further comprises transmitting the portion to the one or more students through an electronic educational system accessible to the one or more students.

Another aspect of the invention is an education fund for storing assets on behalf of a student, the education fund comprising an account for accumulating assets from activities designed to incentivise individuals to perform for the benefit of one or more students' education.

Another aspect of the invention is a method of accumulating assets in a trust for the educational use of a student based on the participation of the student in educational exercises. The method comprises monitoring the participation of the student in educational exercises offered through an online education system. The method also comprises calculating an amount of reward based on the participation of the student in educational exercises. The method further comprises notifying the trust to include the amount of the reward.

For purposes of summarizing the invention, certain aspects, advantages and novel features of the invention have been described herein. Of course, it is to be understood that not necessarily all such aspects, advantages or features will be embodied in any particular embodiment of the invention.

### BRIEF DESCRIPTION OF THE DRAWINGS

The present invention is described in more detail below in connection with the attached drawings, which are meant to illustrate and not to limit the invention, and in which:

FIG. 1 illustrates a block diagram of an education system, according to aspects of an embodiment of the invention;

FIG. 2 illustrates a block diagram of a student area of the education system of FIG. 1, according to aspects of an embodiment of the invention;

FIG. 3 illustrates a block diagram of a teacher area of the education system of FIG. 1, according to aspects of an embodiment of the invention;

FIG. 4 illustrates a block diagram of a family area of the education system of FIG. 1, according to aspects of another embodiment of the invention;

FIG. 5 illustrates a block diagram of a notification system of the education system of FIG. 1, according to aspects of an embodiment of the invention;

FIG. 6 illustrates a block diagram of a student system of the education system of FIG. 1, according to aspects of another embodiment of the invention;

FIG. 7 illustrates a block diagram of a teacher system of the education system of FIG. 1, according to aspects of an embodiment of the invention; and

FIG. 8 illustrates a block diagram of a family system of the education system of FIG. 1, according to aspects of another embodiment of the invention.

### DETAILED DESCRIPTION OF THE PREFERRED EMBODIMENT

The present invention provides an education system that accounts for the differing learning styles of students. For example, according to one aspect of the invention, the education system includes a student area where students participate in educational exercises, such as lessons, games, or the like. During the educational exercises, the education system analyzes the student's particular learning modality and adapts the educational exercises to that specific modality. According to one embodiment, the adaptation of the education system to the student's learning modality may continue throughout the student's use of the system.

The present invention also provides an education system that helps teachers develop curriculum and assign activities to individual or groups of students. For example, according to one aspect of the invention, the education system includes a teacher area where teachers may browse offered and suggested curriculum. Such curriculum may correspond to corrective or restorative curriculum, gifted or advanced student curriculum, or the like. In addition, the foregoing curriculum may advantageously be highly relevant in that the curriculum corresponds to the subject areas in which the student is currently engaged.

The teacher area may also provide teachers the ability to enter testing or other results of student progress into the education system, or the like. The foregoing entries may be through, for example, voice recognition technologies, such as image-to-text, or by scanner cards, or the like.

The present invention also provides an education system that provides effective feedback to parents. For example, according to another aspect of the invention, the education system includes a family area where family members, such as parents, can view the progress of their child's learning. Moreover, the education system includes a notification system that informs family members of, for example, the foregoing entries of the teacher. A skilled artisan will recognize that the term parents, as used herein, may include guardians, spouses, siblings, other relatives, benefactors such as corporations or student or family acquaintances, or the like who may have an interest in the education of a participating student.

The present invention also provides an education system that incentivises each participant in the student's education to use the education system. For example, through participation in the foregoing educational exercises, students accumulate various rewards. For example, students may accumulate various rewards for performing their daily homework or other various exercises. According to one aspect of the invention, the students may redeem these various rewards for prizes at any number of participating vendors. In addition, the education system incentivises the parents through rewards. For example, parents can earn financial rewards, such as cash-back for college tuition, by purchasing products through the education system. Parents may redeem the foregoing rewards through, for example, donations made towards one or more college funds. For example, parents may accumulate donations to the one or more college funds through online Internet purchasing activities, use of one or more credit cards designed to donate a portion of the purchase price, through retail activities with commercial retail partners who distribute a portion of each purchase price, or the like.

Moreover, the education system incentivises teachers through offers of free or discounted goods for the personal and professional use by the teacher. In addition, the education system may provide daily teacher, school and PTA (parent teacher associations) cash award programs where, for example, students or professionals nominate teachers to receive cash prizes. A skilled artisan will recognize from the disclosure herein that such cash award programs may be based on a wide number of activities, including random selection, greatest participation, achievement, economic status, or the like.

Also, the education system incentivises vendors by giving the vendors the opportunity to market the vendor's products to a large customer base having demographics related to education.

To facilitate the complete understanding of the invention, the remainder of the detailed description describes the invention with reference to the FIGURES, wherein like elements are referenced with like numerals throughout.

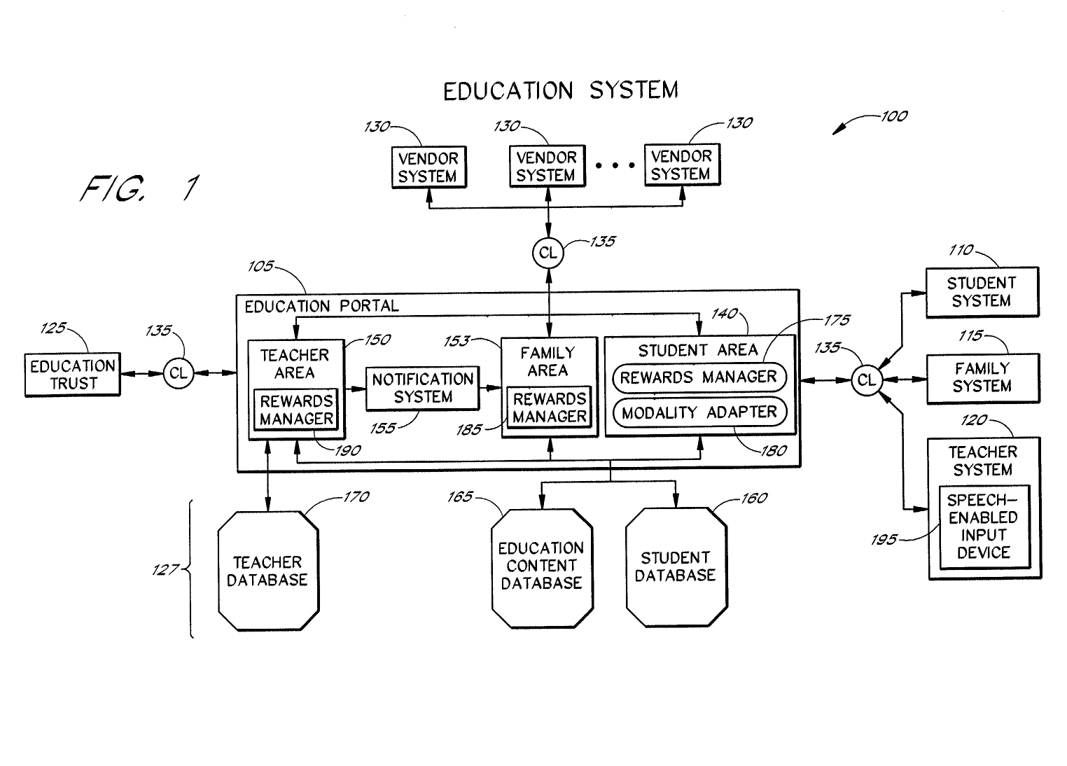

FIG. 1 illustrates a block diagram of an education system 100 according to aspects of an embodiment of the invention. As shown in FIG. 1, the education system 100 includes an education portal 105, a student system 110, a family system 115, a teacher system 120, an education trust 125, one or more databases 127, and one or more vendor systems 130, all communicating with one another through one or more communication links 135. As illustrated in FIG. 1, the student system 110, the family system 115, and the teacher system 120 access the education portal 105 over the communication link 135. Moreover, the education portal 105 is advantageously connected to one or more databases 127, while the one or more vendor systems 130 advantageously connect to the education portal 105 through the communication link 135. Also as, illustrated in FIG. 1, the education portal 105 is advantageously connected to the education trust 125 through the communication link 135.

As disclosed in the foregoing, the education system 100 includes the education portal 105. According to one embodiment, the education portal 105 advantageously comprises a web server. Typically, web servers serve content over the Internet using one or several Internet language protocols, such as the Hypertext Mark Up Language (HTML) or the Extensible Mark Up Language (XML). A web server accepts requests from Internet browsers, such as those commercially available from Netscape, Microsoft Corporation, or the like, and then returns the appropriate electronic documents. A number of servers or client-side technologies can be used to increase the power of the web server beyond its ability to deliver standard electronic documents. For example, these technologies include Common Gateway Interface (CGI) scripts, Secure Sockets Layer (SSL) security, and Access Server Pages (ASPs).

According to one embodiment, the educational portal 105 comprise a web server, an application server, or a combination of both, such as those commercially available from Apache, Cold Fusion, or the like.

According to one embodiment, the education portal 105 may advantageously provide educational or other electronic content through the web server, such as, for example, educational presentations or exercises. In addition, the education portal 105 may advantageously provide periodic and timely feedback to parents and students of student performance related to the foregoing education exercises. Moreover, the education portal 105 may advantageously provide educational materials, such as school curriculum, lessons and exercises, educational articles, or the like, to the teacher. Further, the education portal 105 may advantageously provide offers for educational products from the vendors to the parents, students, or teacher.

Although the education portal 105 is disclosed with reference to the foregoing embodiments, the invention is not intended to be limited thereby. Rather, a skilled artisan will that recognize from the disclosure herein that the education portal 105 may advantageously comprise one or more computing devices capable of conducting the activities described herein with reference to the education portal 105. For example, the educational portal 105 may comprise a private network for private school, a national network, a computer workstation, an interactive television, an interactive kiosk, a personal mobile computing device (such as a digital assistant), a mobile phone, a lap top or the like, a wireless communications device, a smartcard, an embedded computing device, or any similar device that can interact with the communication link 135. In such alternative systems, the operating systems will likely differ and be adapted for the particular device. However, according to one embodiment, the operating systems advantageously continue to provide the appropriate communication protocols required to establish communication with the communication link 135.

The education system 100 also includes the student system 110. According to one embodiment, the student system 110 comprises a conventional general purpose computer using one or more microprocessors, such as, for example, an Intel-based processor. Moreover, the student system 110 includes an appropriate operating system, such as, for example, an operating system capable of displaying graphics or windows such as Microsoft Windows, Unix, Linux, or the like. As shown in FIG. 1, the student system 110 may connect to the communication link 135 by a conventional service provider through services, such as, for example, a dial-up connection, digital subscriber lines (DSL), cable modem connection, fiber or wireless connection, or the like. According to another embodiment, the student system 110 may connect to the communication link 135 through network connectivity, such as, for example, a public, private, local, or wide area network or any combination of foregoing. According to one embodiment, the operating system includes a TCP/IP stack that handles all incoming and outgoing message traffic passed over the communication link 135. The student system 110 allows the student to connect to the education portal 105 and participate in the exercises and lessons provided by the education portal 105.

Although the student system 110 is disclosed with reference to the foregoing embodiments, the invention is not intended to be limited thereby. Rather, a skilled artisan will recognize from the disclosure herein a wide number of alternative embodiments of the student system 110, including almost any computing device capable of sending or receiving information from another computing device. For example, the student system 110 may include a computer workstation, an interactive television, an interactive kiosk, a personal mobile computing device (such as a digital assistant), a mobile phone, a laptop or the like, a wireless communications device, a smartcard, an embedded computing device, or any similar device that can interact with the communication link 135. In such alternative systems, the operating systems will likely differ and be adapted for the particular device. However, according to one embodiment, the operating systems advantageously continues to provide the appropriate communication protocols required to establish communication with the communication link 135.

The education system 100 also includes the family system 115. According to one embodiment of the invention, the family system 115 comprises a computing device similar to those disclosed in the preferred or alternative embodiments of the student system 110. The family system 115 allows the parents to connect to the education portal 105 and view various information corresponding to the student's education. For example, the information may advantageously include homework assignments, or performance indicators corresponding to how well the student performed on various educational exercises, quizzes, exams, or the like. The family system 115 also allows the parents to connect to the education portal 105 to purchase products, participate in offers from the vendor systems 130, and monitor the student's education trust 125.

The educational system 100 also includes the teacher system 120. According to one embodiment of the invention, the teacher system 120 comprises a computing device similar to those in the preferred and alternative embodiments of the student system 110 and the teacher system 115. Moreover, the teacher system 120 may include a speech-enabled input device 195. The speech-enabled input device 195 may advantageously receive speech input and convert the input to digital output, such as commands, data entry, or the like. In one embodiment, the teacher system 120 allows the teacher to connect to the educational portal 105. Moreover, the teacher system 120 allows for information to be retrieved from the education portal 105 and presented on the teacher system 120 to the teacher.

As disclosed in the foregoing, FIG. 1 illustrates the education trust 125. According to one embodiment, the education trust 125 comprises a fund designated to accumulate valuable assets for the benefit of the education of students. For example, according to one embodiment, the valuable assets may advantageously include money, or vouchers for education, scholarships, room and board, supplies, discount coupons, and the like.

According to one embodiment, the education trust 125 is created and maintained by a third party that is in the business of maintaining trusts or similar instruments. According to another embodiment, the education trust 125 is a financial account established in a commercial bank or the like. Although the education trust 125 is disclosed with reference to the foregoing embodiments, the invention is not intended to be limited thereby. Rather, a skilled artisan will recognize from the disclosure herein a wide number of alternative embodiments of the education trust 125, including any type or combination of funds where monies, or other entities of value, can be accumulated and used at a later time.

In addition, a skilled artisan will recognize from the disclosure herein that the education trust 125 may advantageously comprises one or more trusts, usable by any one or combination of the student, the parents, the teacher or the like. Also, donations may be made to the education trust 125 through private company promotions, such as credit card companies or airlines offering donations to the education trust 125 for any one or combination of activities those companies wish to encourage. In addition, corporations may include matching funding or the like for their employees, the children of their employees, underprivileged or scholarship students, gender or racial scholarships for particular careers, or the like. Also, the education trust 125 may comprise or receive funding as a charitable organization, or a wide number of other benefactors having a wide number of motivations for participating in the education of a student. Thus, the education trust 125 acts as a vehicle for collecting rewards from a wide number of sources for a wide number of reasons, redeemable to the benefit of the student or one or more participants involved in the education of the student.

According to one embodiment, the education trust 125 may comprise or receive funding from a plurality of sources, such as, for example, a credit card featuring cash-back for college tuition. As another example, the education trust 125 may comprise or receive funding from a portion of online purchases made by the parents at online retailers. As yet another example, the education trust 125 may comprise or receive funding from participating retailers who credit the education trust 125 with a portion of purchases made at the retailers by the parents. A skilled artisan will recognize from the disclosure herein that the education trust 125 is not limited to the foregoing embodiments, but comprises of a wide variety of vehicles for collecting rewards from a wide number of sources for a wide number of reasons, redeemable to the benefit of the student or one, or more participants involved in the education of the student.

As disclosed in the foregoing, FIG. 1 also illustrates the vendor system 130. According to one embodiment, the vendor system 130 comprises one or more Internet websites or portals residing on one or more computer systems configured to serve informational content over a network. The website may correspond to a particular Internet domain name and include the content associated with a particular organization. As used herein, the term website is generally intended to encompass both the hardware and software server components that serve the informational content. Moreover, the website may include one or more network “back-end” hardware and software components, including any non-standard or specialized components that interact with the server components to perform services for the website users.

According to one embodiment, the vendor system 130 comprises a website that provides various functionality for allowing customers to purchase products including products selected from the websites of other organizations. The website may advantageously be operated by a business entity that handles the various order processing, shipping, collections, and customer service tasks associated with the sale of goods. In one embodiment of the invention, the vendor system 130 may include online e-tailers, such as, for example, etoys.com, amazon.com, and the like. According to one embodiment, a participant in the student's education may use rewards from the education trust 125 to purchase or otherwise acquire items from the vendor systems 130.

As illustrated in FIG. 1, the education system 100 includes one or more databases 127. In one embodiment of the invention, the databases 127 comprise an SQL server, or any database system capable of storing and retrieving information, such as those commercially available from, for example, the Oracle Corporation or IBM.

Although the databases 127 are disclosed with reference to the foregoing embodiments, the invention is not intended to be limited thereby. Rather, a skilled artisan will recognize from the disclosure herein a wide number of alternative embodiments of the databases 127 including almost any computing device capable of storing, accessing and retrieving information.

According to one embodiment, the databases 127 comprise of one or more secure servers for accessing and storing information. In one embodiment of the invention, the databases 127 include a student database 160, an education content database 165, and a teacher database 170. In one embodiment, the student database 160 contains information related to a student, such as demographic information, learning modality information, historical performance information, and the like. The demographic information includes information such as the student's name, address, school information, family information, and the like. In one embodiment, the education content database 165 includes lessons and exercises for students, educational articles, school curriculum, and the like. In one embodiment, the teacher database 170 contains information related to a teacher, such as demographic information, class and school information, and the like. The demographic information includes information such as the teacher's name, address, school information, and the like.

A skilled artisan will recognize from the disclosure herein that the content of the databases 127 may be cross-referenced, cross-indexed, or separately stored in other databases besides those disclosed in the foregoing. In addition, the databases 127 may advantageously be remotely stored or communicate remotely to the education portal 105. According to another embodiment, the databases 127 may advantageously be logically or physically separated from each other or from the education portal 105.

FIG. 1 also illustrates the communication link 135 connecting the education portal 105 with the student system 110, the family system 115, the teacher system 120, the education trust 125, the databases 127, and the vendor systems 130. According to one embodiment, the communication link 135 preferably comprises the Internet. The Internet as used throughout this disclosure is a global network of computers. The structure of the Internet, which is well known to those of ordinary skill in the art, includes a network backbone with networks branching from the backbone. These branches in turn have networks branching from them, and so on. Routers move information packets between network levels, and then from network to network until the packet reaches the neighborhood of its destination. From the destination, the destination network's host directs the information packet to the appropriate terminal or node. In one advantageous embodiment, the Internet routing hubs comprise Domain Name System (DNS) servers using Transfer Control Protocol-Internet Protocol (TCP/IP) as is well known in the art. The routing hubs connect to one or more other routing hubs via high speed communication links.

One popular part of the Internet is the World Wide Web. The World Wide Web contains different computers which store documents capable of displaying graphical and textual information. The computers that provide information on the World Wide Web are typically called websites. As disclosed in the foregoing, a website may be defined by an Internet address having an associated electronic page. The electronic page can be identified by a Uniform Resource Locator (URL). Generally, an electronic page is a document that organizes the presentation of text, graphical images, audio, video, and so forth.

Although the communication link 135 is disclosed in terms of the preferred embodiment, one of ordinary skill in the art will recognize from the disclosure herein that the communication link 135 may include a wide range of interactive communication links. For example, the communication link 135 may include interactive television networks, telephone networks, wireless data transmission systems, two-way cable systems, customized private or public computer networks, interactive kiosk networks, automatic teller machine networks, direct links satellite networks, cellular networks, or the like.

As disclosed in the foregoing, FIG. 1 also illustrates the education portal 105. As shown in FIG. 1, the education portal 105 comprises a student area 140, a teacher area 150, a family area 153, and the notification system 155, all connected and communicating with each other within the education portal 105. In one embodiment, the student area 140 also includes a rewards manager 175 and a modality adapter 180, each of which includes aspects that will be disclosed in further detail below.

In one embodiment of the invention, the student area 140 comprises a portion of the electronic information available to the education portal 105. As illustrated in FIG. 1, the student area 140 communicates with the family area 153 and the teacher area 150. Moreover, the student area 140 accesses and uses the student database 160 and the education content database 165. Although the student area 140 is disclosed with reference to its preferred embodiment, the student area 140 may include any computer system that serves informational content over a network using the standard protocols of the World Wide Web or the like.

As illustrated in FIG. 1, the educational portal 105 includes the teacher area 150. In one embodiment of the invention, the teacher area 150 comprises a website or any computer system capable of serving informational content over a network using standard protocols of the World Wide Web. In one embodiment, the teacher area 150 includes all or parts of a website or a web page, such as, for example, one or more user viewable HyperText documents. According to another embodiment, the teacher area 150 also includes a rewards manager 190, aspects of which are disclosed in further detail below.

As illustrated in FIG. 1, the teacher area 150 is connected to and interacts with the student area 140 and the family area 153 and the notification system 155. The teacher area 150 may connect to the family area 153 through the notification system 155. Also as illustrated in FIG. 1, the teacher area 150 accesses the student database 160, the education content database 165, and the teacher database 170.

FIG. 1 also illustrates the family area 153. In one embodiment of the invention, the family area 153 comprises a portion of the electronic information available to the education portal 105. In another embodiment of the invention, the family area 153 also includes a rewards manager 185, aspects of which are disclosed in further detail below. In another embodiment of the invention, the family area 153 comprises portions of a website or a web page, such as, for example, one or more user viewable HyperText documents.

As illustrated in FIG. 1, the family area 153 is connected to and interacts with the student area 140 and the teacher area 150. Also as illustrated in FIG. 1, the family area 153 is connected to the notification system 155. The family area 153 accesses and uses the student database 160 and the education content database 165.

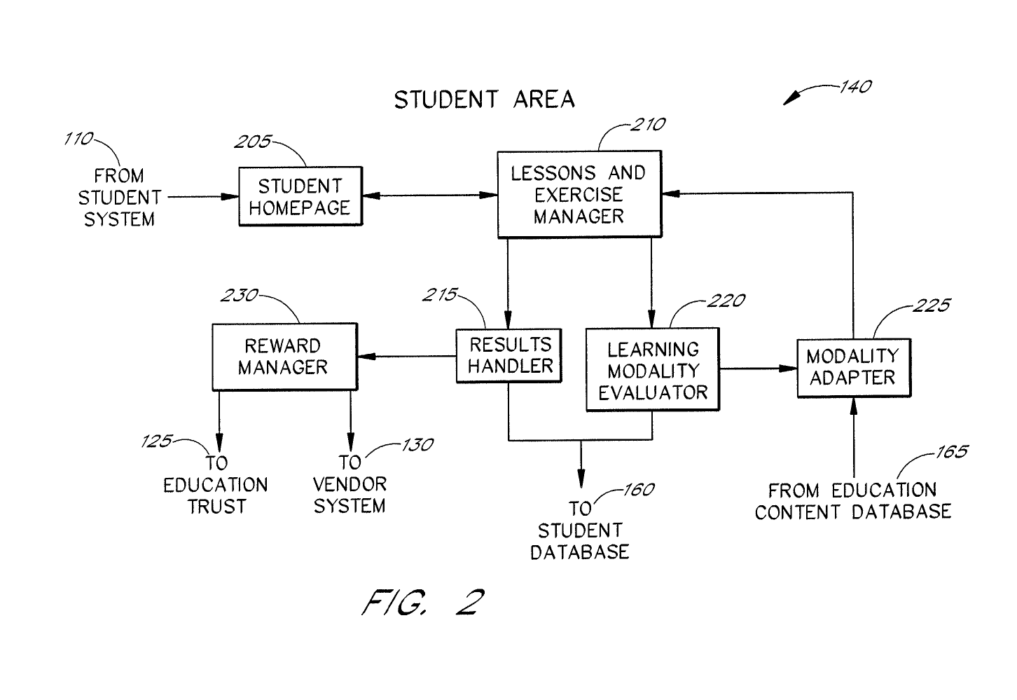

FIG. 2 illustrates a block diagram of the student area 140 according to aspects of an embodiment of the invention. As illustrated in FIG. 2, the student area 140 includes a student home page 205, a lesson and exercise manager 210, a results handler 215, a learning modality evaluator 220, a modality adaptor 225, and a reward manager 230.

In one embodiment, the student home page 205 may advantageously present educational content, such as presentations and one or more lessons or exercises, from the lessons and exercises manager 210. According to one embodiment, the presentations, lessons, or exercises advantageously include interactive audio-visual games, quizzes, tests, puzzles, presentations, or the like. According to another embodiment, the foregoing educational content relates to the current activities or studies of the student. For example, the educational content may include additional or homework exercises surrounding the student's studies for the day, week, semester, or the like. In addition, the educational content may include exercises designed for learning impaired, slower, gifted or normal student abilities. Thus, the educational content may advantageously be highly relevant and applicable to real-time needs.

The foregoing educational content may be stored in the education content database 165, and upon request, be forwarded to the lessons and exercise manager 210. Along the way, the modality adapter 225 filters or alters the educational content according to the learning modality of the particular student. As the student participates in the presentations, lessons or exercises, the exercise manager 210 submits the student's performance and corresponding information to the results handler 215 and the learning modality evaluator 220.

According to one embodiment, the results handler 215 stores the student's performance in the student database 160 and submits the student's performance to the reward manager 230. The reward manager 230 credits the student with rewards according to the student's performance. The reward manager 230 may store the student's rewards in the education trust 125, the student area 140, one or more vendor systems 130, the student system 110, or any combination thereof.

Thus, the student area 140 advantageously incentivises students to use the education system 100 by providing valuable educational resources, purchasing venues, and redeemable rewards for participating in student activities. Such incentivisation advantageously ensures that the students will continue to use the education system 100.

In one embodiment of the invention, the learning modality evaluator 220 uses the student's performance in the lessons and exercises to determine the learning modality of the student. For example, if the student succeeds in visual exercises but not in auditory exercises, the learning modality evaluator 220 determines that the student prefers visual learning. Once the learning modality evaluator 220 analyzes the student's learning preference, the learning preference is transmitted to the modality adapter 225 and the student database 160. As described in the foregoing, the modality adapter 225 use the analysis received from the learning modality evaluator 220 to tailor subsequent lessons and exercises presented to the student.

According to one embodiment, the learning modality evaluator 220 continually updates the determination of the student's learning preference or modality. For example, the learning modality evaluator may advantageously store various modalities or combinations of modalities for specific subjects, types of exercises, or the like.

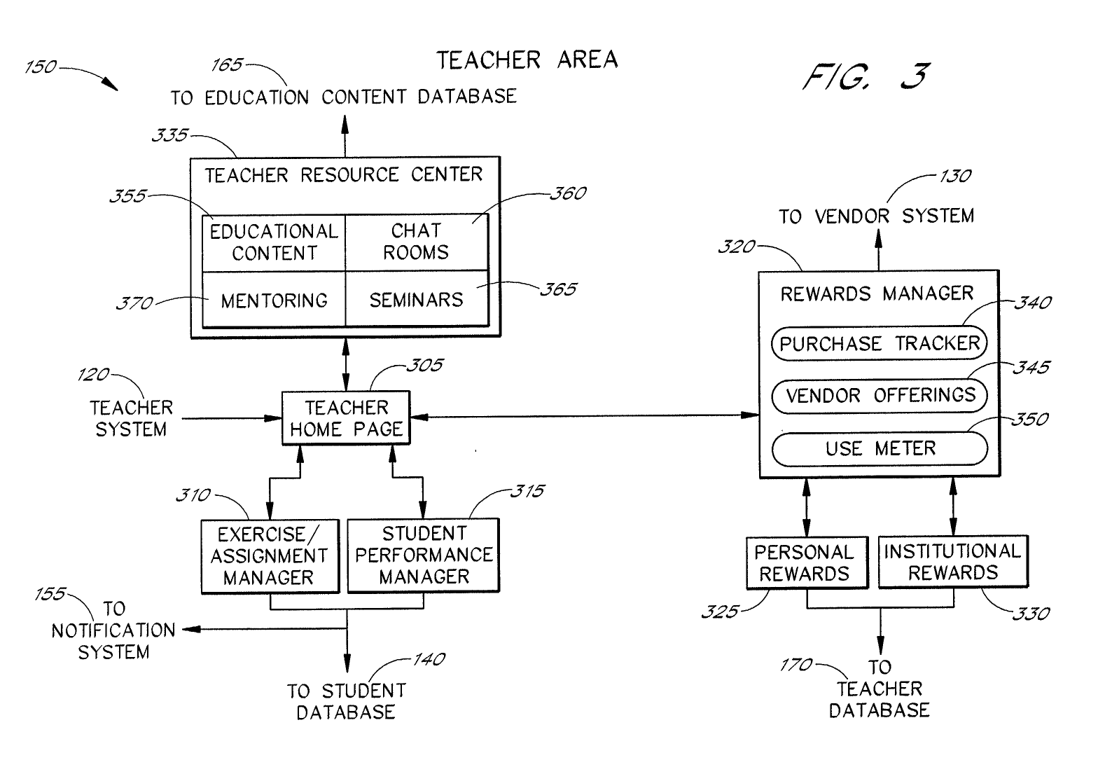

FIG. 3 illustrates the teacher area 150 according to aspects of an embodiment of the invention. In one embodiment, the teacher area 150 includes a teacher home page 305, an exercise assignment manager 310, a student performance manager 315, a reward manager 320, an indication of personal rewards 325, an indication of institutional rewards 330, and a teacher resource center 335. According to one embodiment of the invention, the teacher area 150 is accessed by teachers through the teacher system 120 communicating with the education portal 105. According to one embodiment, the teacher home page 305 provides the teacher the ability to access the exercise and assignment manager 310, thereby creating and managing exercises and assignments for students. The exercises and assignments may advantageously be stored in the student database 140 and to the notification system 155.

As illustrated in FIG. 3, the teacher home page 305 also interacts with the student performance manager 315. The student performance manager 315 monitors student performance and provides information corresponding to those performances to the teacher. The student performance manager 315 stores performance results, such as grades, in the student database 140 and notification system 155.

In one embodiment of the invention, the teacher may request that the exercise and assignment manager 310 provide the student with appropriate exercises and assignments even after the student has left the classroom and has arrived at home. Using the student performance manager 315, the exercise and assignment manager 310 determines the appropriate exercises and assignments for the student to participate in the next time the student accesses the student home page 205. For example, the appropriate exercises and assignments may include such topics as spelling, vocabulary, math, science, history, geography, or the like. In one embodiment of the invention, the appropriate exercises and assignments are presented in a tutorial format. Although the exercises and assignments are disclosed in terms of the foregoing embodiments and examples, one of ordinary skill in the art will recognize from the disclosure herein that the exercises and assignments may include a wide range of educational activities or tutorials presented to educate the student according to the relevant educational or curriculum needs of the student at the time of the presentation.

The teacher home page 305 also interacts with the rewards manager 320 to manage rewards based on at least the teacher's activities. In one embodiment, the rewards manager 320 includes a purchase tracker 340 and vendor offerings 345 and a use meter 350. Thus, as the teacher purchases educational content through online vendors, such as, for example, vendors providing the vendor systems 130, the rewards manager 320 through the purchase tracker 340, tracks purchases and credits the teacher for such activity. According to one embodiment, the vendors may provide special offers, discounts, coupons or the like through the vendor offerings 345 which, when taken advantage of, may provide increased rewards for the teacher. In addition, as the teacher uses the education portal 105, one of the vendor systems 130, the vendor offerings 345, or other designated computer systems or offerings, the use meter 350 advantageously tracks and credits the teacher for such activity.

As illustrated in FIG. 3, the rewards manager 320 communicates the indication of personal rewards 325 and institutional rewards 330 to the teacher database 170, so as to record and manage the rewards accumulated and earned by teachers. Thus, as the teacher accumulates rewards, those rewards may be designated as redeemable for personal items desired by the teacher, for institutional items desired by the educational institution the teacher belongs to, or the like. The reward amount and corresponding information may advantageously be stored in the teacher database 170.

A skilled artisan will recognize from the disclosure herein that the activities of the teacher may advantageously produce incremental rewards for the teacher, the institution, the student, or some or all of the same.

FIG. 3 also illustrates the teacher home page 305 communicating with the teacher resource center 335. In one embodiment, the teacher resource center 335 includes educational content 355, chat rooms 360, seminars 365, and mentoring information 370. The teacher resource center 335 advantageously retrieves educational content from the educational content database 165 through teacher selection, system suggestions, historical data, or the like. In addition, multiple teachers may communicate through the chat rooms 360, the seminars 365, and the mentoring area 370 to provide one another ideas, support, mentoring, or the like.

Thus, the teacher area 150 advantageously incentivises teachers to use the education system 100 by providing valuable educational resources, purchasing venues, and redeemable rewards for participating in the foregoing activities. Such incentivisation advantageously ensures that the teachers will benefit from, and thereby continue to use, the education system 100.

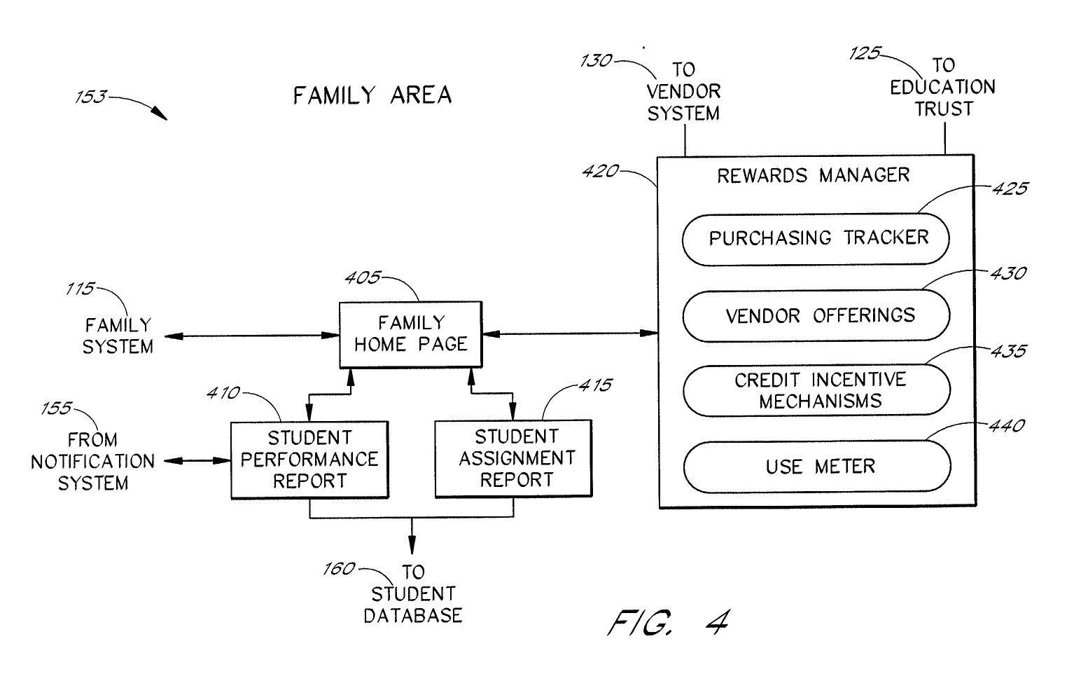

FIG. 4 illustrates the family area 153 according to aspects of an embodiment of the invention. As illustrated in FIG. 4, the family area 153 includes a family home page 405, student performance reports 410, student assignment report 415, and a rewards manager 420. As illustrated in FIG. 4, the family accesses the family home page 405 through the family system 115. The family home page 405 communicates with the notification system 155 to retrieve the student performance reports 410 and the student assignment reports 415. According to one embodiment, the performance report 410 and the assignment report 415 are stored in the student database 160.

According to one embodiment, the performance report 410 advantageously informs the family on a student's performance during lesson and exercises. In addition, the assignment report 415 advantageously informs the family on assignments that are pending, recently completed, or in the near of far future. The foregoing reports may advantageously be generated immediately following the student's performance or the teacher's or system's assignment, thereby providing immediate feedback to the parents on the progress and outstanding workload of their student. Such immediate feedback provides parents with the ability to closely monitor their students educational progress. In addition, knowledge of outstanding assignments and subject matter allows parents the ability to carefully plan vacations, provide additional educational experiences corresponding to currently studied subject matter, and monitor homework of the student.

Although the foregoing reports are disclosed with reference to preferred and alternative embodiments, a skilled artisan will recognize from the disclosure herein that such reports offer a wide number of customizable functionality. For example, the foregoing reports may be transmitted to the family area on a scheduled or periodic basis. In addition, the reports may be communicated to any of a wide number of computing devices, such as, for example, personal computing devices, digital assistants, cell phones, personal computers, or the like.

Similar to the student area 140, the family area 153 includes the rewards manager 420 configured to track, store, and provide for redeeming of the family rewards. In addition, the rewards manager 420 includes a credit incentive mechanism 435. According to one embodiment, the credit incentive mechanism 435 provide families, through the family home page 405, incentives to use the system or purchase goods. Portions of such purchases are advantageously donated as rewards to, for example, the education trust 125. According to one embodiment, the credit incentive mechanism 435 includes a lottery based incentive system where the family accumulates chances to win rewards, such as college tuition, based upon the family's use of the system. Thus, families earn chances to win rewards based proportionally on the family's use of the system. According to another embodiment, the credit incentive mechanism 435 provides the family with the ability to choose whether to credit all rewards to one or multiple accounts benefiting one or multiple individuals.

Thus, the family area 153 advantageously incentivises teachers to use the education system 100 by providing purchasing venues and redeemable rewards for participating in the foregoing activities. Such incentivisation advantageously ensures that the students or students associated with the family will benefit, thereby encouraging the family to continue to use the education system 100.

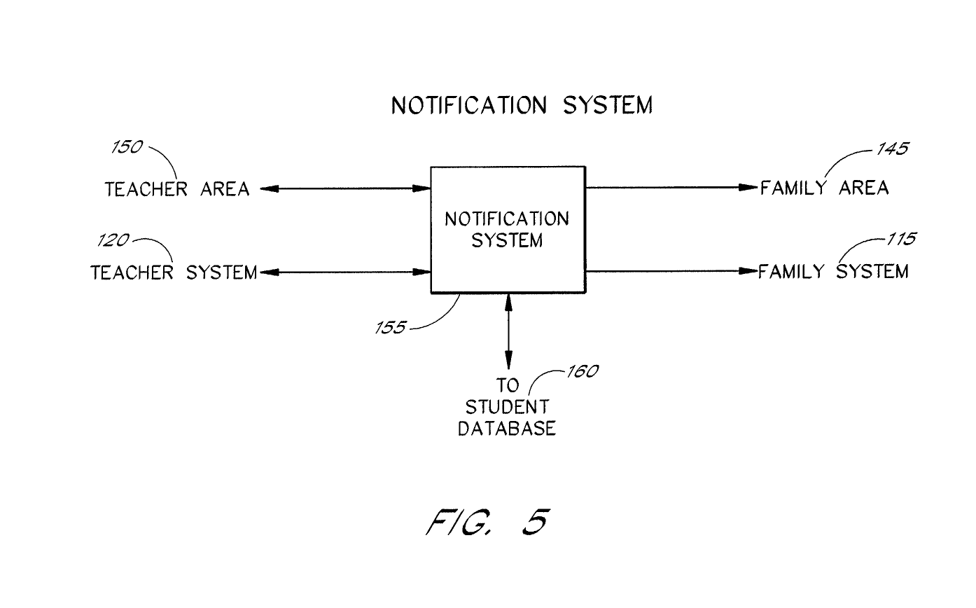

FIG. 5 illustrates a notification system 155 according to aspects of one embodiment of the invention. As illustrated in FIG. 5, the notification system 155 communicates with the teacher area 150, the teacher system 120, the family area 145, the family system 115, and the student database 160. According to one embodiment, the teacher area 150 sends a notification of performance reports, assignments, or both to the notification system 155, which are then transmitted by the notification system 155 to the family area 153, the family system 115, or both. In one embodiment, the notification system 155 transmits notifications to the family system 115 via email, voice mail, electronic page, or the like. In one embodiment, the notification system 155 notifies the family system 115 by placing a message, or similar notification, in the family area 153.

A skilled artisan will recognize from the disclosure herein that the teacher, the educational institution, the student, or some or all of the foregoing, may advantageously employ the notification system 155 to inform parents of school announcements, activities, closures, emergencies, or the like. In addition, the skilled artisan will recognize that the notification system 155 may advantageously allow the teacher to pass messages to the parents, such as, for example, class performance statistics, comments on the student's behavior or understanding of the materials. Such messages may advantageously employ the functionality of conventional messaging systems, such as, for example, broadcasting, multi-recipient designations, recipient groupings, or the like. Thus, the teacher may automatically generate one message for all students scoring in a particular percentile of the class, or for performing their homework on time, or the like, while generating alternative messages for other percentiles, late homework, or the like.

Thus, the notification system 155 advantageously provides communication between the participants in the student's education. For example, the teacher supplies immediate feedback to the parents of assignments, student performances, or the like. In addition, the notification system 155 allows for additional information to be passed to the parents by the teacher or educational institution.

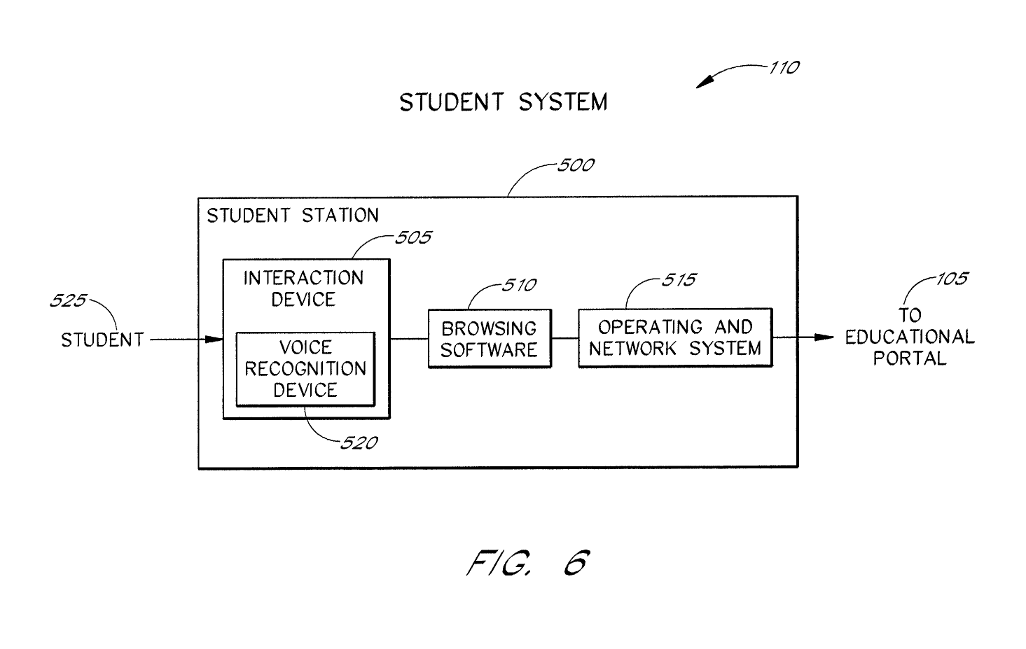

FIG. 6 illustrates the student system 110 according to aspects of one embodiment of the invention. As illustrated in FIG. 6, the student system 110 includes a student station 500, such as a personal computer, computer system, workstation, or other computing device or system, such as a kiosk, cell phone, or wireless device. The student station 500 includes an interaction device 505, browsing software 510, and an operating and network system 515. As illustrated in FIG. 6, student 525 accesses the student station 500 to gain access to the educational portal 105. In one embodiment, the interaction device 505 includes any software or hardware system capable of receiving and sending data, including graphics and text. In one embodiment, the browsing software 510 includes any software that can display text and graphics such as, for example, Microsoft Explorer Netscape Navigator, or the like.

According to one embodiment of the invention, the operating and network system 515 includes any system programs required to operate a computer system and to facilitate network access. In one embodiment, the operating and network system 515 may include one of many operating systems commercially available, such as, for example, Microsoft Windows, UNIX, Linux, or the like. As illustrated in FIG. 6, the interaction device 505, in one embodiment, may include a voice recognition device 520. The voice recognition device 520 includes any device capable of receiving voice input and outputting digital information to the system it resides on. The voice recognition device 520 may advantageously reside on the interaction device 505 to allow a student 525 to use the interaction device 505 without manual data entry.

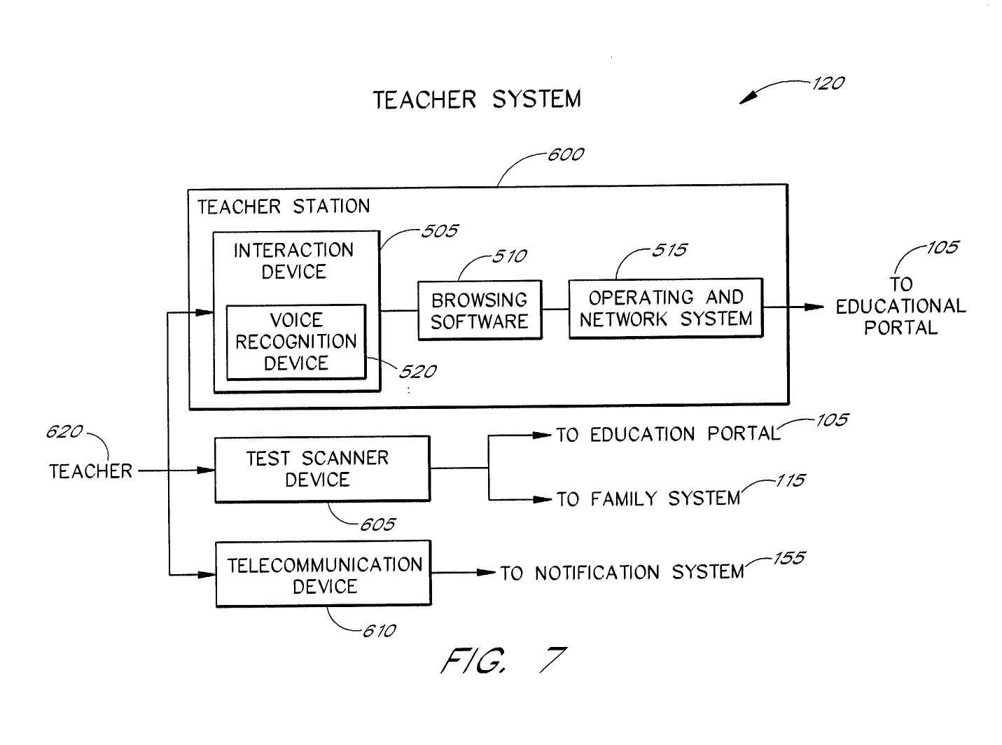

FIG. 7 illustrates a block diagram of the teacher system 120 according to aspects of an embodiment of the invention. As illustrated in FIG. 7, the teacher system 120 includes a teacher station 600, a test scanner device 605, and a telecommunication device 610. As illustrated in FIG. 7, the teacher station 600 comprises a personal computer, computer system, workstation, or other computing device or system, such as a kiosk, cell phone, or wireless device. The teacher station 600 includes components similar to the student station 500, such as, for example, the interaction device 505, the browsing software 510, and the operating and network system 515. In one embodiment of the invention, the interaction device 505 includes the voice recognition device 520.

In one embodiment of the invention, the test scanner device 605 includes any device capable of reading or scanning physical documents and converting the scanned input into a digital output. In one embodiment of the invention, the test scanner device 605 includes a card reader capable of reading examination cards, or similar objects used to measure student performance. In one embodiment of the invention, the telecommunication device 610 includes any device capable of receiving and transmitting data over the communication link 135. In one embodiment of the invention, the telecommunication device 610 includes a telephone or a cellular phone, or the like.

As illustrated in FIG. 7, the teacher 620 may access the teacher station 600, the test scanner device 605, and the telecommunication device 610. The teacher station 600 may connect to the education portal 105. The test scanner device 605 may connect to the education portal 105, the family system 115, and the notification system 155. As illustrated in FIG. 7, the telecommunication device 610 may connect to a notification system 155.

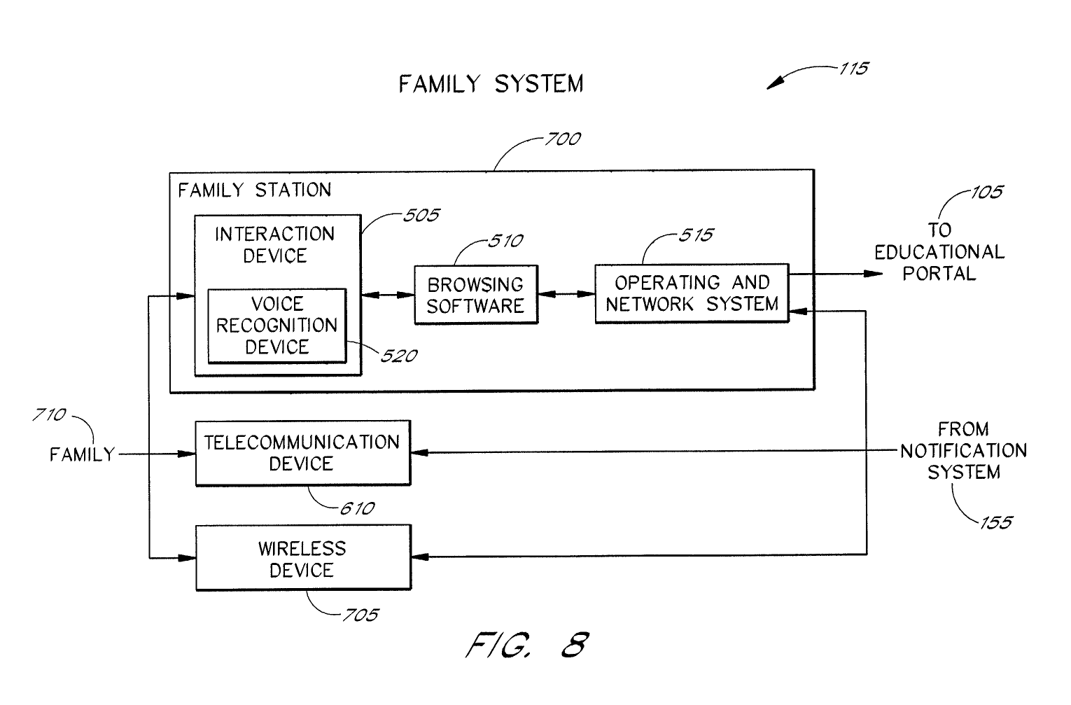

FIG. 8 illustrates the family system 115 according to aspects of an embodiment of the invention. As illustrated in FIG. 8, the family system 115 includes a family station 700, the telecommunication device 610, and a wireless device 705. As illustrated in FIG. 8, the family station 700 is similar to the student station 500 and the teacher station 600. In addition, the wireless device 705 includes any device capable of receiving and transmitting digital information over wireless networks or by wireless signals, including, for example, a personal digital assistant, a personal computing device, a computer laptop capable of transmitting wireless data, or the like. The telecommunication device 610 and the wireless device 705 receive data from the notification system 115.

Although the foregoing invention has been described in terms of certain preferred embodiments, other embodiments will be apparent to those of ordinary skill in the art from the disclosure herein. For example, specific functionality may be moved from one component to another through software changes in the corresponding websites. For example, the notification system 155 may automatically search out data to form into notifications which are subsequently sent to the parents. In addition, the disclosed functionality may advantageously be performed through business logic or application state machines. For example, the state of data in a particular database may drive an event, such as a notification, student assignment, or increase in reward. Moreover, virtually any interested party may provide promotional or direct funding to the education trust 125 for one or multiple beneficiaries.

Additionally, other combinations, omissions, substitutions and modifications will be apparent to the skilled artisan in view of the disclosure herein. Accordingly, the present invention is not intended to be limited by the reaction of the preferred embodiments, but is to be defined by reference to the appended claims.

What is claimed is:

1. An education system for determining a learning style of a student and presenting educational content to the student, wherein the presentation is at least partially adapted to the learning style of the student, the education system comprising:
an educational lesson manager which provides educational content to a student through a presentation;
a learning modality evaluator which evaluates a student performance to determine a learning style of the student; and
a modality adapter which modifies at least a portion of the presentation based on the learning style of the student.

2. The education system of claim 1, wherein the presentation comprises an interactive presentation.

3. The education system of claim 2, wherein the interactive presentation comprises one or more exercises for the student to perform.

4. The education system of claim 3, wherein the one or more exercises comprise a vocabulary improvement game.

5. The education system of claim 3, wherein the one or more exercises comprise a reading game.

6. The education system of claim 3, wherein the one or more exercises are assigned by a teacher.

7. The education system of claim 2, wherein the interactive presentation includes portions presented in differing learning styles, and wherein the learning modality evaluator determines the learning style of the student by comparing the performances of the student during the differing learning styles.

8. The education system of claim 7, wherein the learning modality evaluator continually updates the determination of the learning style of the student.

9. The education system of claim 7, wherein the modality adapter continually modifies the presentation based on the determination of the learning style of the student by the learning modality evaluator.

10. The education system of claim 2, wherein the interactive presentation comprises one of an audio and visual presentation.

11. The education system of claim 1, wherein the learning style comprises of visual learning style.

12. The education system of claim 1, wherein the learning style comprises of an auditory learning style.

13. The education system of claim 1, wherein the learning style comprises of a kinesthetic learning style.

14. The education system of claim 1, further comprising a database for storing the learning style of a student.

15. A method of incentivising participants in a student's education to use an electronic education system which conveys at least information related to the student's education, the method comprising the steps of:
providing teacher incentives to a teacher to access an electronic education system, wherein the electronic education system enhances the education of a student;
providing student incentives to a student to access the electronic education system; and
providing guardian incentives to a guardian of the student to access the electronic education system.

16. The method of claim 15, wherein the teacher incentives include access to educational content.

17. The method of claim 15, wherein the teacher incentives include the option of assigning one or more exercises to the student.

18. The method of claim 17, wherein the teacher incentives also include automatic evaluating and tracking of the performance of the student during the assigned one or more exercises.

19. The method of claim 17, wherein the teacher incentives also include notification of the performance of the student during the assigned one or more exercises.

20. The method of claim 15, wherein the teacher incentives include rewards for using or purchasing items through the electronic education system.

21. The method of claim 15, wherein the student incentives include rewards for performing one or more exercises available on the electronic education system.

22. The method of claim 21, wherein the rewards are redeemable at one or more vendors connected to the electronic education system.

23. The method of claim 21, wherein the rewards are stored in an education trust.

24. The method of claim 15, wherein the guardian incentives include notification of the performance of the student during one or more exercises.

25. The method of claim 15, wherein the guardian incentives include rewards for using or purchasing items through the electronic education system.

26. The method of claim 25, wherein the rewards are stored in an education trust.

27. An automatic notification system for notifying a guardian of a performance of a student during one or more educational exercises, the notification system comprising:
an electronic education system which stores an indicator of the performance of a student during one or more educational exercises;
a transmission system connected to the education system; and
a guardian computing device connected to the transmission system, which receives a notification of the indicator from the electronic education system through the transmission system, thereby providing a guardian of the student with feedback on the performance of the student during the one or more educational exercises.

28. The automatic notification system of claim 27, wherein the electronic education system includes a teacher system for entering the indicator.

29. The automatic notification system of claim 27, wherein the electronic education system is configurable to provide automatic notification through the transmission system to one or more guardian computing devices.

30. The automatic notification system of claim 27, wherein the guardian computing device comprises a wireless computing device.

31. The automatic notification system of claim 27, wherein the guardian computing device comprises a telephone and the notification comprises a telephone message.

32. An education system for improving the education of a student, the education system comprising:
a trust which stores rewards on behalf of a student, the rewards being earned by one of the student, a guardian of the student, a benefactor of the student, and a teacher; and
an education portal providing one or more educational exercises adapted to a learning style of the student, wherein the education portal includes a notification system which generates a notification for a guardian computing device of a result of the student performing the one or more educational exercises, the result corresponding to the performance of the one or more educational exercises.

33. The education system of claim 32, wherein the rewards are earned through purchases made through an instrument of a financial company.

34. The education system of claim 33, wherein the instrument comprises a credit card.

35. The education system of claim 32, wherein the rewards are earned through use of the education portal.

36. The education system of claim 32, wherein the rewards are earned through purchases made over a computer network.

37. The education system of claim 32, wherein the rewards are earned through the performance of the one or more educational exercises by the student.

38. An education system comprising:
a teacher area which accesses educational content on behalf of a teacher;
a student area which provides one or more interactive educational exercises that are at least partially adapted to a learning modality of a student;
a notification system which generates a notification having performance indicators corresponding to the performance of the student during the one or more educational exercises;
a family area which receives the notification; and
one or more databases which store data corresponding to at least portions of the educational content, the learning modality, and the performance indicators;
wherein use of the education system by one of the teacher, the family, and the student, produces rewards to be stored in a trust on behalf of one of the one of the teacher, the family, and the student.

39. A method of incentivising one or more participants in a student's education to use an electronic education system which conveys at least information related to the student's education, the method comprising the steps of:
offering one or more rewards based on an amount of use of an electronic education system by one or more participants in a student's education, wherein the one or more rewards correspond to at least one desired item of the at least one participant.

40. The method of claim 39, wherein the one or more participants include a teacher.

41. The method of claim 39, wherein the one or more participants include a guardian of the student.

42. The method of claim 39, wherein the one or more participants include the student.

43. The method of claim 39, wherein the at least one desired item includes goods for personal use.

44. The method of claim 39, wherein the at least one desired item includes educational goods.

45. The method of claim 39, wherein the at least one desired item is included in an education trust.

46. The method of claim 39, wherein the at least one desired item further comprises of goods desired by children.

47. A method of providing relevant online educational content and exercises to a user, the method comprising the steps of:
selecting homework exercises or presentations from a database storing educational content, the selection being based on subject matter corresponding to subject matter a student currently is engaged in;
assigning the selected exercises or presentations to the student through an electronic educational system accessible to the student; and
monitoring the student's performance during at least one of the selected exercises or presentations.

48. The method of claim 47, wherein the exercises or presentations comprise tutorial exercises or presentations.

49. The method of claim 47, wherein the exercises or presentations comprise interactive games.

50. The method of claim 47, wherein subject matter a student currently is engaged comprises the current day's scholastic activities.

51. A method of distributing homework to one or more students through an electronic educational system, the method comprising the steps of:
receiving a request from the teacher to assign particular homework to one or more students;
selecting a portion of educational content stored in one or more databases, the portion corresponding to the particular homework; and
transmitting the portion to the one or more students through an electronic educational system accessible to the one or more students.

52. An education fund for storing assets on behalf of a student, the education fund comprising an account for accumulating assets from activities designed to incentivise individuals to perform for the benefit of one or more students' education.

53. The education fund of claim 52, wherein activities include making purchases with a credit card designed to forward commissions to the education fund.

54. The education fund of claim 52, wherein activities include making online purchases from vendors who forward commissions to the education fund.

55. The education fund of claim 52, wherein activities include making online purchases through vendors who forward commissions to the education fund.

56. The education fund of claim 52, wherein activities include making purchases from retailers who forward commissions to the education fund.

57. The trust of claim 52, wherein the activities include participation by a student in educational exercises offered through an online education system.

58. A method of accumulating assets in a trust for the educational use of a student based on the participation of the student in educational exercises, the method comprising the steps of:
monitoring the participation of the student in educational exercises offered through an online education system;
calculating an amount of reward based on the participation of the student in educational exercises; and
notifying the trust to include the amount of the reward.
